(19) United States
(12) Patent Application Publication
(10) Pub. No.: US 2012/0036386 A1
(43) Pub. Date: Feb. 9, 2012

(54) SERVER MONITORING SYSTEM

(75) Inventors: SHU-HSIEN CHOU, New Taipei (TW); BI-HUI TAN, Shenzhen City (CN); LI-WEN GUO, Shenzhen City (CN); KANG-BIN WANG, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/005,742

(22) Filed: Jan. 13, 2011

(30) Foreign Application Priority Data
Aug. 3, 2010 (CN) 201010243721.7

(51) Int. Cl. G06F 11/30

(52) U.S. Cl. 713/340

(57) ABSTRACT

A server managing system includes a first server unit, a second server unit, and a monitor device connected to the first server unit and the second server unit in series. Each of the first server unit and the second server unit comprises multiple hardware components and a microcontroller connected to the multiple hardware components. The microcontroller monitors the multiple hardware components and sends monitored hardware information to the monitor device.

### BACKGROUND

1. Technical Field

The present disclosure relates to server monitoring systems, more particularly a server monitoring system configured to monitor a plurality of server units which are connected in series.

2. Description of Related Art

A server system (e.g., blade servers) usually includes a mass of server units (e.g., blades of the servers) mounted in a server rack. Each of the server units can work independently. The server units of the server system are preferably controlled and unitedly monitored. A typical server monitor system utilizes a computer connected to the server units in parallel. The computer can control and monitor the server units one by one. Thus, the computer monitors each of the server units for a predetermined time period. The server units of the server system cannot be monitored all the time. The computer may not monitor the server units in real time.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a server monitoring system in accordance with an embodiment.

FIG. 2 is a detailed block diagram of a server unit of the server monitoring system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

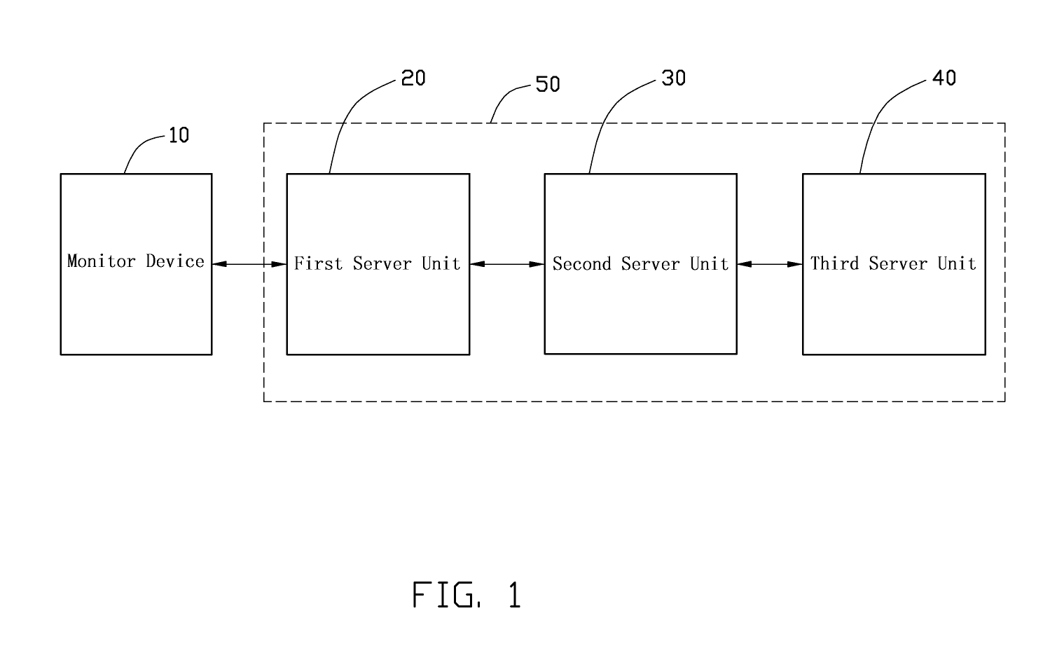

Referring to FIG. 1, an embodiment of a server monitoring system includes a monitor device 10 and a server system 50. The server system 50 includes a plurality of server units (two or more server units). In one embodiment, a first server unit 20, a second server unit 30, and a third server unit 40 are used as shown in FIG. 1. The monitor device 10, the first server unit 20, the second server unit 30, and the third server unit 40 are connected in series. Each of the first server unit 20, the second server unit 30, and the third server unit 40 includes hardware and software systems that can perform various functions. The monitor device 10 can send commands to and/or receive information from the first server unit 20, the second server unit 30, and the third server unit 40 in an ordinal sequence.

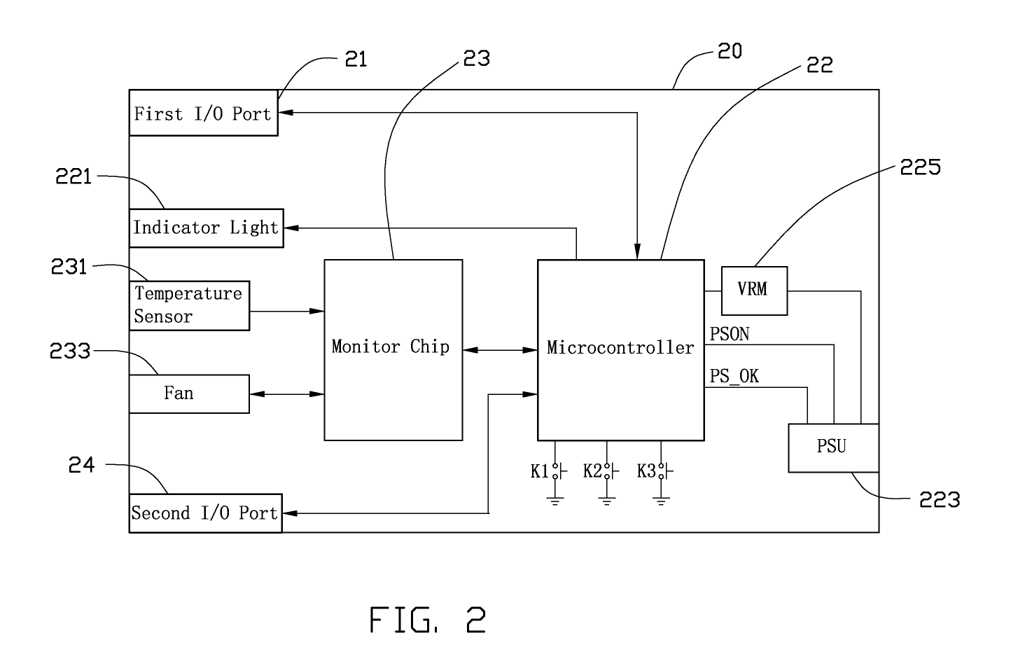

Referring to FIG. 2, the first server unit 20 includes a first I/O port 21, a microcontroller 22, a monitor chip 23, and a second I/O port 24. The first I/O port 21 communicatively connects to the monitor device 10. The second I/O port 24 communicatively connects to a next one of the server units. In an exemplary embodiment, the second I/O port 24 of the first server unit 20 is communicatively connected to the second server unit 30.

The first server unit 20 further includes an indicator light 221, a power supply unit (PSU) 223, and a voltage regulation module (VRM) 225, which all are connected to the microcontroller 22. The indicator light 221 is connected to the microcontroller 22 and indicates an identification code of the first server unit 20. The PSU 223 includes a power OK (PS_OK) pin and a power supply on (PSON) pin connected to the microcontroller 22. When a voltage at the PSON pin is set from high to low level, the PSU 223 is powered on, and then the voltage at the PS_OK pin of the PSU 223 rises to a high level to indicate that output rails of the PSU 223 are all powered on. The microcontroller 22 can set the voltage at the PSON pin to low or high level and detect whether the PSU 223 can be normally powered on or off. The PSU 223 supplies power to the VRM 225 and other electronic components installed in the first server unit 20. The microcontroller 22 is connected to the VRM 225 to detect a current flowing through the VRM 225. Then the monitor device 10 can calculate the power of the VRM 225. A first key K1, a second key K2, and a third key K3 are connected to the microcontroller 22. The first key K1 increases the identification code of the first server unit 20. The second key K2 decreases the identification code of the second server unit 30. The third key K3 affirms the setting of the identification code. For instance, if the first server unit 20 is assigned with an identification code 1 initially and the first key K1 is pressed once, the identification code of the first server unit 20 changes from 1 to 2. If the second key K2 is pressed once, the identification code of the first server unit 20 changes from 1 to 0. The monitor device 10 can access the server units according to their identification codes.

The first server unit 20 further includes a temperature sensor 231, and a fan 233. The temperature sensor 231 is mounted in the first server unit 20 and configured to sense a temperature in the first server unit 20. The monitor chip 23 is connected to the temperature sensor 231 and the fan 233 for monitoring the temperature and a rotating speed of the fan 233 according to the monitored temperature.

In one embodiment, the microcontroller 22, the monitor chip 23, the first key K1, the second key K2, the third key K3, and the indicator light 221 are mounted in an integrated circuit board. This integrated circuit board can be utilized and mounted in each of the server units of the server system 50 to monitor the corresponding server units and send the monitored information to the monitor device 10.

A configuration of each of the second server unit 30 and the third server unit 40 is similar to that of the first server unit 20 as disclosed above. The second server unit 30 is in communication with the monitor device 10 via the first server unit 20. The third server unit 40 is in communication with the monitor device 10 via the second server unit 30 and the first server unit 20.

To monitor the server system 50, the monitor device 10 sends read commands to the first server unit 20, the second server unit 30, and the third server unit 40. Then the first server unit 20, the second server unit 30, and the third server unit 40 send information about the hardware components (including the fan 233, the VRM 225, the PSU 223, etc.) monitored by the microcontroller and the monitor chip to the monitor device 10. The monitor device 10 decodes and displays corresponding information about each of the server units of the server system.

In one embodiment, the monitor device 10 and the server units are connected in series. Thus, the monitor device 10 can monitor and control all of the server units in the server system unitedly and simultaneously, which may control and monitor the server units more accurately.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A server monitoring system comprising:
a first server unit;
a second server unit, and
a monitor device connected to the first server unit and the second server unit in series;
wherein each of the first server unit and the second server unit comprises multiple hardware components and a microcontroller connected to the multiple hardware components, and the microcontroller is configured to monitor the multiple hardware components and send monitored information to the monitor device.

2. The server monitoring system of claim 1, wherein the multiple hardware components comprises a power supply unit, and the power supply unit comprises a power supply on (PSON) pin and a power OK (PS_OK) pin connected to the microcontroller.

3. The server monitoring system of claim 1, wherein the multiple hardware components comprises a voltage regulation module connected to the microcontroller, and the microcontroller is configured to monitor a current flowing through the voltage regulation module.

4. The server monitoring system of claim 1, wherein each of the first server unit and the second server unit further comprises a monitor chip connected to the microcontroller, the multiple hardware components comprises a temperature sensor and a fan mounted in each of the first server unit and the second server unit, and the microcontroller is connected to the temperature sensor and the fan via the monitor chip.

5. The server monitoring system of claim 4, wherein the monitor chip is connected to the temperature sensor and the fan, and the monitor chip is configured to read temperature information from the temperature sensor and monitor a rotating speed of the fan.

6. The server monitoring system of claim 1, wherein each of the first server unit and the second server unit comprises an indicator light connected to the microcontroller to indicate an identification code of each of the first server unit and the second server unit.

7. The server monitoring system of claim 6, wherein each of the first server unit and the second server unit has a first key, a second key, and a third key connected to the microcontroller, the first key is configured to increase the identification code, the second key is configured to decrease the identification code, and the third key is configured to confirm the setting of the identification code.

8. The server monitoring system of claim 1, further comprising a third server unit connected to the second server unit in series.

9. A server monitoring system comprising:
a plurality of server units, each of the plurality of server units comprising multiple hardware components and a microcontroller connected to the multiple hardware components, and the microcontroller configured to obtain information of the multiple hardware components; and
a monitor device, connected to the plurality of server units in series, configured to receive the information sent by the microcontroller.

10. The server monitoring system of claim 9, wherein the multiple hardware components comprises a power supply unit, and the power supply unit comprises a power supply on (PSON) pin and a power OK (PS_OK) pin connected to the microcontroller.

11. The server monitoring system of claim 9, wherein the multiple hardware components comprises a voltage regulation module connected to the microcontroller, and the microcontroller is configured to monitor a current flowing through the voltage regulation module.

12. The server monitoring system of claim 9, wherein each of the plurality of server units comprises a monitor chip connected to the microcontroller, the multiple hardware components comprises a temperature sensor and a fan mounted in each of the plurality of server units, the microcontroller is connected to the temperature sensor and the fan via the monitor chip.

13. The server monitoring system of claim 12, wherein the monitor chip is connected to the temperature sensor and the fan to monitor a temperature in each of the plurality of server units and a rotating speed of the fan in each of the plurality of server units.

14. The server monitoring system of claim 13, wherein each of the plurality of server units comprises an indicator light connected to the microcontroller to indicate an identification code of a corresponding one of the plurality of server units.

15. The server monitoring system of claim 14, wherein each of the plurality of server units has a first key, a second key, and a third key connected to the microcontroller, the first key is configured to increase the identification code, the second key is configured to decrease the identification code, and the third key is configured to confirm the setting of the identification code.

16. The server monitoring system of claim 15, wherein the microcontroller, the monitor chip, the indicator light, the first key, the second key, and the third key are integrated in a circuit board which is applicable in each of the plurality of server units.
